(19) United States
(12) Patent Application Publication
(10) Pub. No.: US 2022/0070789 A1
(43) Pub. Date: Mar. 3, 2022

(54) SYSTEM AND METHOD FOR WAKING UP BDA

(71) Applicant: Fiplex Communications, Inc., Doral, FL (US)

(72) Inventor: Ricardo Matias de Goycoechea, Cordoba (AR)

(73) Assignee: Fiplex Communications, Inc., Doral, FL (US)

(21) Appl. No.: 17/465,442

(22) Filed: Sep. 2, 2021

Related U.S. Application Data
(60) Provisional application No. 63/073,676, filed on Sep. 2, 2020.

(51) Int. Cl. H04W 52/14; H04W 4/06; H04W 52/52

(52) U.S. Cl. CPC H04W 52/146; H04W 52/52; H04W 4/06

(57) ABSTRACT

A system for managing an uplink amplification chain in a coverage extension system is disclosed. The system includes a transceiver unit; an uplink amplification chain including one or more amplifiers; and an ON/OFF mechanism that turns ON or OFF the uplink amplification chain totally or partially. The uplink amplification chain is located within the transceiver unit. The ON/OFF mechanism receives from an external source instructions directing the ON/OFF mechanism when to turn ON or OFF the amplification chain totally or partially.

### CROSS REFERENCE TO RELATED APPLICATIONS

This application claims the benefit of U.S. Provisional Application No. 63/073,676 filed Sep. 2, 2020, the disclosure of which is hereby incorporated herein by reference in its entirety.

### FIELD OF THE DISCLOSURE

This disclosure relates generally to communication systems for distributing signals in a communications network.

### BACKGROUND

The use of Signal Boosters, also referred to as bidirectional amplifiers (BDAs), and of Distributed Antenna Systems, also referred to as Fiber DAS or just DAS, which may include at least one DAS Master Unit (MU) and at least one DAS Remote Unit (RU), are the two most popular methods for extending the signal coverage of two-way radio systems in locations with poor reception or without signal coverage, such as indoor areas (buildings, tunnels, subways, etc.) as well as open areas (canyons, cliffs, valleys, etc.). BDA and DAS are bidirectional amplification devices or systems, with two or more amplifiers in an anti-parallel configuration, which provide simultaneous amplification to the downlink and uplink signals. Downlink signals are transmitted by the Base Station towards the Radios or terminal units, and the Uplink signals are transmitted by the Radios or Terminal Units towards the Base Station. The BDA and DAS amplify the signals when, due to physical barriers, the signals cannot propagate and suffer high attenuation. Being an amplifying system or device, the BDA and DAS do not only amplify only the signals but also the received noise. Because they are active components, they also generate noise of their own that is added to the amplified noise. The noise in the uplink direction has a serious impact on the performance of the Base Station receivers, affecting the capability to properly receive signals originating from Radios located far away from the Base Station. This effect is called Near-Far effect and affects all the two-way radio Base Stations that service BDA and DAS devices. As a result, the effective coverage area of a two way Base Station is reduced from its original designed coverage area, which seriously impacts the ability of two way Radio users located far away from the Base Station to obtain radio service. In order to minimize the Near-Far effect, it is important to reduce the uplink noise being generated by a BDA or DAS system towards the Base Station receiver.

Some BDA and DAS are equipped with uplink squelch functionality, which turns off the uplink amplification chain, totally or partially, when there are no uplink signals entering the BDA or DAS at the uplink input ports, or when the uplink signals entering the BDA or DAS at the uplink input ports have a power level that is lower than a predefined value. This squelch feature works well enough but requires a very fast circuitry response in order avoid modifying or altering the uplink signals during the turn on period. During the process of turning an electronic circuit on, there is a transitory time that elapses until the electronic circuit begins to work in a stable manner. When the transitory time period is long, the signals being amplified are distorted during that “turning on” period, which creates issues. For example, in a p25 radio, the symbol time is much smaller when compared with the turning on time, and hence the turn on process distorts the signal, resulting in the loss of many signal symbols, in turn creating synchronization issues in the communication establishing process.

Other BDA and DAS are equipped with a circuitry that controls the ON and OFF mechanism of the uplink output power amplifier stages, managed with a timer that allows the uplink output power amplifier stages to remain ON for a predefined or adjustable period of time after the uplink input port of the BDA or DAS stops receiving input uplink signals. That is, amplifiers that are not fast with respect to their turning on process, once turned on, they remain ON for a certain period, allowing subsequent communications to be established without the need to be turned back on every time that a new signal is received. So even when distortion occurs during the first time the amplifier is turned on due to the slow turning on process, the subsequent communications will not be distorted because the amplifier circuitry will be ON. This method typically does not avoid modifying or altering the first uplink signal received at the uplink input port of the BDA or DAS, but due to the use of the timer and the uplink output power amplifier stages remaining ON, the subsequent uplink signals (e.g., walkie talkie communications) received by the BDA, then amplified and transmitted to the base station by the BDA, will not be affected by the turn ON period. For example, when a police officer uses his or her radio for the first time, the communication from the officer is the first signal that passes through the BDA, resulting in the BDA being turned ON, and when the BDA is not fast enough with respect to the turning on process, that first call will be distorted or will have quality issues. In that scenario, a police station answers the first call, and then the officer calls again (i.e., generating a subsequent uplink signal) such as for example:

initial call: “police station, this is Officer Jones reporting, I need support”

second call: “Officer Jones, this is the police station, what is the status”

third call: “police station, this is Officer Jones, there has been a bank robbery”

The second, third and all other calls between the officer and the station are referred to as the “subsequent” calls. Since the BDA remains “ON”, then all those subsequent calls (or signals) passing through the BDA will not be distorted by the BDA turning on process, while the first one (initial call) does experience distortion. This squelch feature works well enough, but allows the BDA or DAS uplink chain to be ON, which causes noise to radiate to the Base Station receiver even when no uplink signals are being amplified by the BDA or DAS.

Therefore, there is a need in the art for an improved method and system for reducing the Near Far effect in a wireless coverage extension system.

### BRIEF SUMMARY OF THE DISCLOSURE

The following presents a simplified summary of the disclosure in order to provide a basic understanding of some aspects of the various embodiments disclosed herein. This summary is not an extensive overview of every detail of every embodiment. It is intended to neither identify key or critical elements of every embodiment nor delineate the scope of every disclosed embodiment. Its sole purpose is to present some concepts of disclosure in a simplified form as a prelude to the more detailed description that is presented later.

A system for managing an uplink amplification chain in a coverage extension system is disclosed. The system includes a transceiver unit; an uplink amplification chain including one or more amplifiers; and an ON/OFF mechanism that turns ON or OFF the uplink amplification chain totally or partially. The uplink amplification chain is located within the transceiver unit. The ON/OFF mechanism receives from an external source instructions directing the ON/OFF mechanism when to turn ON or OFF the amplification chain totally or partially.

The following description and annexed drawings set forth certain illustrative aspects of the disclosure. These aspects are indicative, however, of but a few of the various ways in which the principles disclosed may be employed. Other advantages and novel features disclosed herein will become apparent from the following description when considered in conjunction with the drawings.

### BRIEF DESCRIPTION OF THE FIGURES

The drawings, in which like numerals represent similar parts, illustrate generally, by way of example, but not by way of limitation, various embodiments discussed in the present document.

FIG. 1 shows a BDA or a MU or a RU with an ON/OFF mechanism to turn ON or turn OFF the uplink amplification chain totally or partially in accordance with one embodiment.

FIG. 2 another embodiment in which an external source manages the ON/OFF mechanism, and the ON/OFF mechanism manages a radiofrequency (RF) connection and disconnection circuitry.

FIG. 3 shows an RF connection and disconnection circuitry implemented as an external circuitry and managed by an ON/OFF mechanism in accordance with one embodiment.

FIG. 4 shows a similar implementation of the system illustrated in FIG. 3 but with the ON/OFF mechanism implemented as an internal circuitry of the BDA or MU or RU.

FIG. 5 illustrates a BDA or MU or RU similar to the BDA, MU, or RU from FIG. 1, but wired or wireless directly or indirectly connected to a Fire Alarm system in accordance with one embodiment.

FIG. 6 illustrates an implementation similar to the system of FIG. 5 but where the ON/OFF mechanism is external to the BDA or MU or RU in accordance with one embodiment.

### DETAILED DESCRIPTION OF THE DISCLOSURE

The foregoing summary, as well as the following detailed description of certain embodiments of the subject matter set forth herein, will be better understood when read in conjunction with the appended drawings. In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that variations may be made without departing from the scope of the subject matter disclosed herein. It should also be understood that the drawings are not necessarily to scale and in certain instances details may have been omitted, which are not necessary for an understanding of the disclosure, such as details of fabrication and assembly. Furthermore, references to “one embodiment” are not intended to be interpreted as excluding the existence of additional embodiments that also incorporate the recited features. The following detailed description is, therefore, not to be taken in a limiting sense, and the scope of the subject matter disclosed herein is defined by the appended claims and their equivalents.

The present disclosure describes a system that solves the problems with the prior art. The exemplary implementations disclosed herein include a mechanism to externally instruct the BDA or DAS when to turn on and turn off the uplink amplification chain, totally or partially. For example, an amplifier in the uplink amplification chain may be implemented as a digital variable gain RF amplifier. If more than one amplifying stage is to be turned OFF (or gain decreased), in one embodiment the amplifying stage (in the uplink direction) closer to the base station would be turned OFF first.

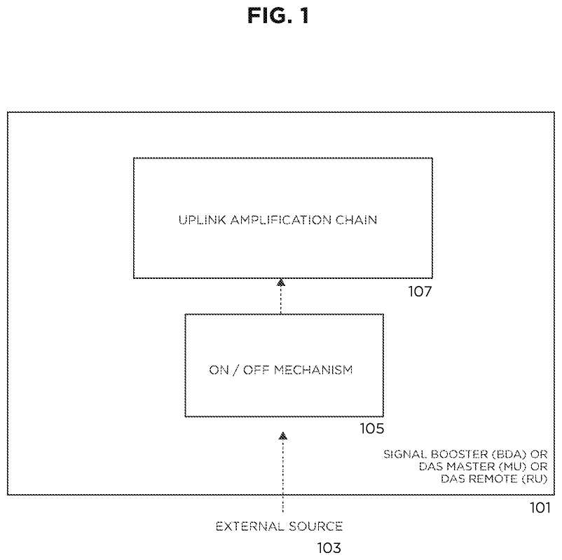

FIG. 1 shows a BDA or a MU or a RU 101 with an ON/OFF mechanism 105 that is used by the BDA or MU or RU 101 to learn from an external source 103, when it must turn ON or turn OFF the uplink amplification chain 107 totally or partially, while the BDA or MU or RU 101 is energized. In one embodiment, the BDA/MU/RU 101 is “ON” or energized but one or more amplifiers in the amplification chain 107 is shut down, OFF, or programmed to have a zero gain. In another embodiment, the BDA/MU/RU 101 is completely OFF.

The ON/OFF mechanism 105 can be a mechanical ON/OFF switch or an ON/OFF button (which would require an actuator), or a dry contact sensing device such as, but not limited to, an opto-coupled sensor, a relay, or any other type of ON/OFF device. These features differ from the prior art in that conventional methods for turning on a BDA involve turning the BDA on when receiving signals from the radios or the Base Station, captured by the antenna, but there is no BDA that is ready to start the amplifying operation when, for example, a fire alarm goes off and there is an emergency, which is the precise time that the BDA (or DAS) needs to begin the turning on process. The external source can be the fire alarm system or an on/off button. Most Public Safety systems need to operate when the alarm system is on, or when there is an emergency, and should remain OFF during the rest of the time while there is no emergency and hence, no firefighters/first responders, etc. are inside the building.

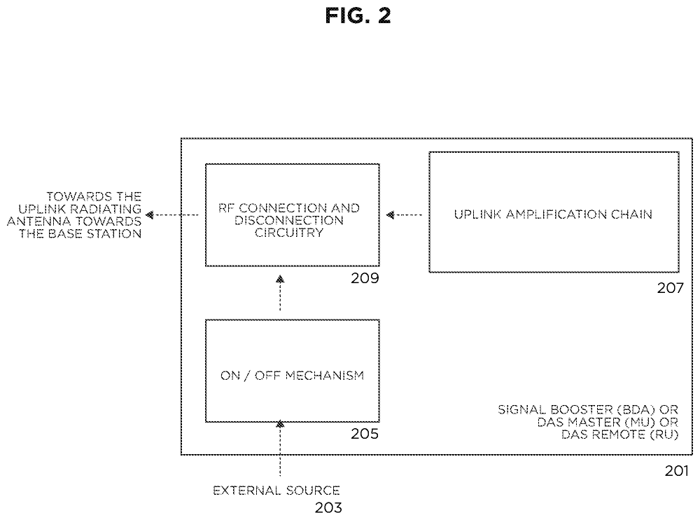

FIG. 2 shows another embodiment in which the external source 203 manages the ON/OFF mechanism 205, and the ON/OFF mechanism manages a radiofrequency (RF) connection and disconnection circuitry 209 that connects or disconnects the uplink output of the amplification chain 207 from the uplink radiating antenna towards the base station, or provides attenuation between uplink output of the amplification chain 207 and the uplink radiating antenna towards the base station. This technique is intended to force the BDA or DAS to work only under certain situations and to avoid having the BDA or DAS operating all the time because the uplink noise being generated by the BDA or DAS and radiated to the Base Station via the antenna is a real problem with prior art systems.

In the embodiment illustrated in FIG. 2 the BDA is operational all the time but the RF connection and disconnection circuitry 209 that is managed by the ON/OFF mechanism 205 (that receives the instruction to turn on or off the amplifying stages from an external source 203), connects or disconnects the working BDA 201 from the donor antenna. The ON/OFF mechanism 205 actuated over the BDA 201, turning on-off the uplink amplification chain 207 (through the RF connection and disconnection circuitry), allows the BDA 201 to be constantly in operation but enables connecting or disconnecting the BDA 201 from the donor antenna, which meets the objective of not having the uplink generated noise reaching the antenna and being radiated to the Base Station if not needed. An alternative option is to attenuate the uplink noise instead of disconnecting the antenna. Attenuating the uplink noise refers reducing its power level while disconnection may refer to providing an infinite (at least in theory) attenuation.

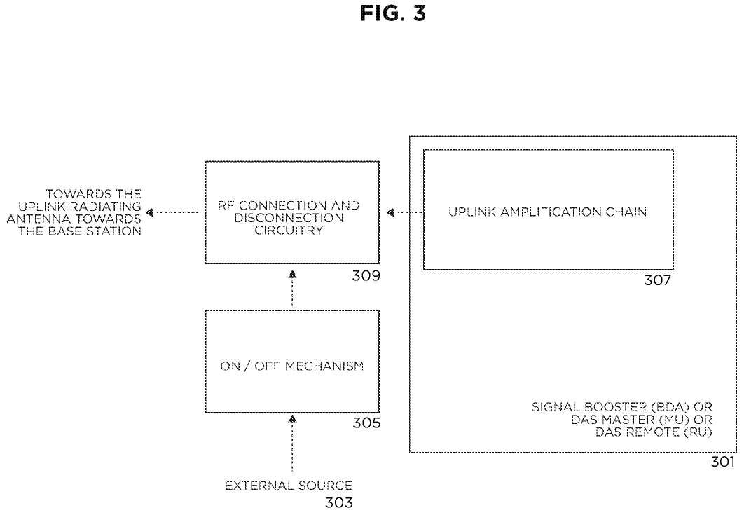

FIG. 3 shows that the RF connection and disconnection circuitry 309 may be implemented as an external circuitry that is managed by the ON/OFF mechanism 305, where the ON/OFF mechanism 305 is an external circuitry of the BDA or MU or RU 301, and where the RF connection and disconnection circuitry 309 alternatively provides attenuation between uplink output of the amplification chain 307 and the uplink radiating antenna towards the base station. The connection/disconnection mechanism 309 may be implemented as a coaxial RF relay that connects and disconnects the antenna, or an RF attenuator that provides high attenuation to both the RF signal and noise coming out of the amplifier.

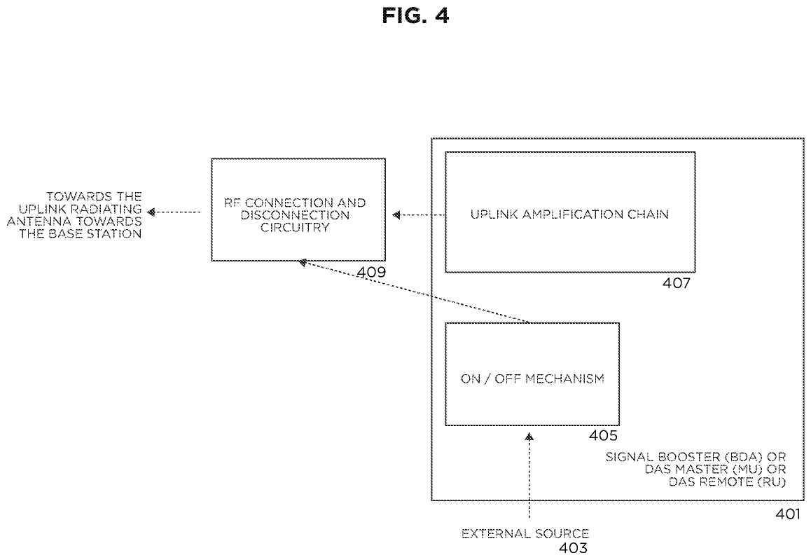

FIG. 4 shows a similar implementation of the system illustrated FIG. 3 but in this implementation the ON/OFF mechanism 405 may be an internal circuitry of the BDA or MU or RU 401.

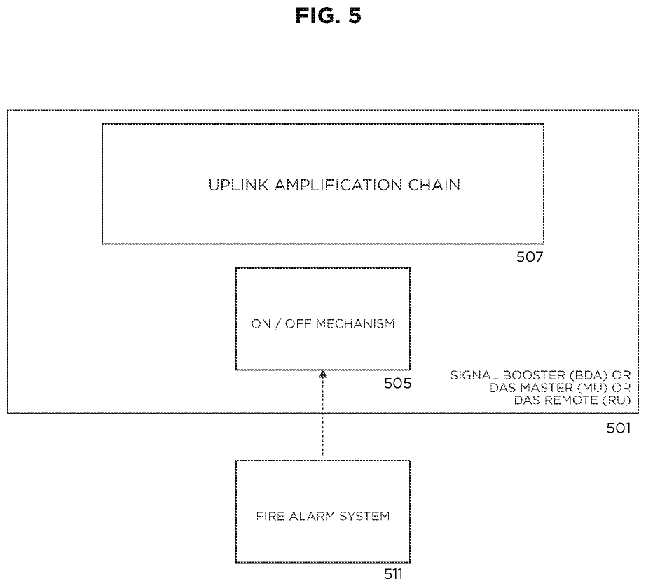

FIG. 5 illustrates a BDA or MU or RU similar 501 to the BDA, MU, or RU 101 from FIG. 1, but wired or wireless directly or indirectly connected to a Fire Alarm system 511. In FIG. 5 the Fire Alarm system 511 may constitute the external source that directly or indirectly actuates over the ON/OFF mechanism 505 of the BDA or MU or RU 501.

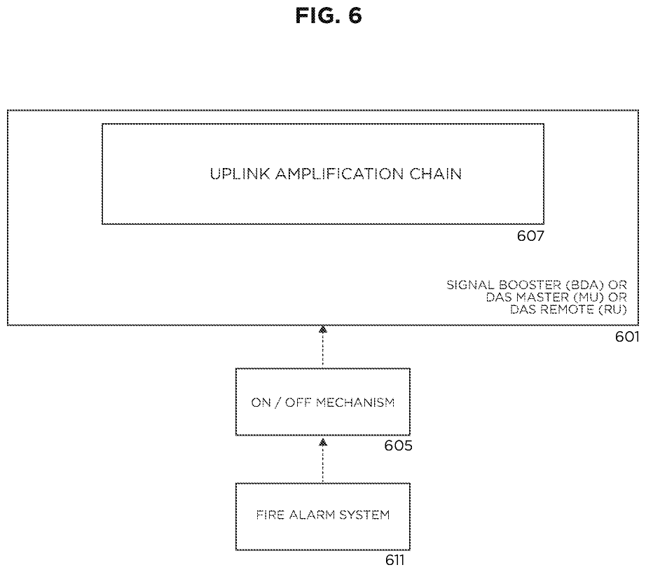

FIG. 6 illustrates an implementation similar to the system of FIG. 5, but where the ON/OFF mechanism 605 is external to the BDA or MU or RU.

The ON/OFF mechanism may be implemented as part of the BDA or MU or RU, or may be an external component that provides the BDA or MU or RU with the instructions to turn ON or turn OFF, totally or partially, the uplink amplification chain. Those instructions may also include instructions to manage the RF connection and disconnection circuitry, where the RF connection and disconnection circuitry can be an internal component of the BDA or MU or RU, or can be an external device.

The descriptions set forth above are meant to be illustrative and not limiting. Various modifications to the disclosed embodiments, in addition to those described herein, will be apparent to those skilled in the art from the foregoing description. Such modifications are also intended to fall within the scope of the concepts described herein. The disclosures of each patent, patent application, and publication cited or described in this document are hereby incorporated herein by reference, in their entireties.

The foregoing description of possible implementations consistent with the present disclosure does not represent a list of all such implementations or all variations of the implementations described. The description of some implementations should not be construed as an intent to exclude other implementations described. For example, artisans will understand how to implement the disclosed embodiments in many other ways, using equivalents and alternatives that do not depart from the scope of the disclosure. Moreover, unless indicated to the contrary in the preceding description, no particular component described in the implementations is essential to the invention. It is thus intended that the embodiments disclosed in the specification be considered illustrative, with a true scope and spirit of invention being indicated by the following claims. Further, the limitations of the following claims are not written in means—plus-function format and are not intended to be interpreted based on 35 U.S.C. 112(f), unless and until such claim limitations expressly use the phrase “means for” followed by a statement of function void of further structure.

What is claimed:

1. A system for managing an uplink amplification chain in a coverage extension system comprising:
a transceiver unit;
an uplink amplification chain comprising one or more amplifiers; and
an ON/OFF mechanism that turns ON or OFF the uplink amplification chain totally or partially;
wherein the uplink amplification chain is located within the transceiver unit; and
wherein the ON/OFF mechanism receives from an external source instructions directing the ON/OFF mechanism when to turn ON or OFF the amplification chain totally or partially.

2. The system of claim 1, wherein the ON/OFF mechanism turns ON or OFF the transceiver unit based on instructions received from the external source.

3. The system of claim 1, wherein the ON/OFF mechanism turns OFF the uplink amplification chain partially by turning OFF one or more amplifiers in the amplification chain.

4. The system of claim 1, wherein the ON/OFF mechanism turns OFF the uplink amplification chain partially by setting one or more amplifiers in the amplification chain to have a zero gain.

5. The system of claim 1, wherein the ON/OFF mechanism comprises a mechanical ON/OFF switch, an ON/OFF button, or a dry contact sensing device.

6. The system of claim 5, wherein the dry contact sensing device comprises an opto-coupled sensor, or a relay.

7. The system of claim 1, wherein the ON/OFF mechanism turns ON the uplink amplification chain partially or totally when the external source alerts the ON/OFF mechanism that there is a fire alarm.

8. The system of claim 1, wherein the ON/OFF mechanism turns OFF the uplink amplification chain totally when the external source alerts the ON/OFF mechanism that there is no fire alarm.

9. The system of claim 1, wherein the external source is a fire alarm system.

10. The system of claim 1, wherein the ON/OFF mechanism is located within the transceiver unit.

11. The system of claim 1, wherein the transceiver unit is a bidirectional amplifier, a remote unit of a distributed antenna system, or a master unit of a distributed antenna system.

12. The system of claim 1, wherein said one or more amplifiers comprise a digital variable gain RF amplifier.

13. A system for managing an uplink amplification chain in a coverage extension system comprising:
a transceiver unit;
an uplink amplification chain comprising one or more amplifiers;
an ON/OFF mechanism that manages the connection, disconnection, or attenuation of uplink signals; and
an RF connection and disconnection circuitry;
wherein the uplink amplification chain is located within the transceiver unit; and
wherein the ON/OFF mechanism receives from an external source instructions directing the ON/OFF mechanism to manage the RF connection and disconnection circuitry to
connect or disconnect an output of the amplification chain from a donor antenna radiating an uplink signal towards a base station, or
to provide attenuation between uplink output signals from the amplification chain and said donor antenna radiating an uplink signal towards a base station.

14. The system of claim 13, wherein the amplification chain is partially or totally ON.

15. The system of claim 13, wherein the RF connection and disconnection circuitry comprises a coaxial RF relay that connects and disconnects the antenna, or an RF attenuator that provides high attenuation to both uplink signals and noise coming out of the amplification chain.

16. The system of claim 13, wherein the ON/OFF mechanism comprises a mechanical ON/OFF switch, an ON/OFF button, or a dry contact sensing device.

17. The system of claim 16, wherein the dry contact sensing device comprises an opto-coupled sensor, or a relay.

18. The system of claim 13, wherein the ON/OFF mechanism is located within the transceiver unit.

19. The system of claim 13, wherein the RF connection and disconnection circuitry is located within the transceiver unit.

20. The system of claim 13, wherein the transceiver unit is a bidirectional amplifier, a remote unit of a distributed antenna system, or a master unit of a distributed antenna system.
